(19) United States
(12) Patent Application Publication
(10) Pub. No.: US 2017/0186026 A1
(43) Pub. Date: Jun. 29, 2017

(54) ONLINE FRIEND REFERRAL SYSTEM

(71) Applicant: Cloudmondo, Inc., Santa Clara, CA (US)

(72) Inventors: Ihab Abu-Hakima, Los Altos, CA (US); Bojan Likar, Cupertino, CA (US); Sungwook Han, Sunnyvale, CA (US)

(21) Appl. No.: 15/387,629

(22) Filed: Dec. 21, 2016

Related U.S. Application Data
(60) Provisional application No. 62/270,043, filed on Dec. 21, 2015.

(51) Int. Cl. G06Q 30/02

(52) U.S. Cl. CPC G06Q 30/0214; G06Q 30/0282; G06Q 50/01

(57) ABSTRACT

Responsive to detecting a referral event, a referral engine can automatically facilitate referrals for service providers by broadcasting a referral inquiry to associates. Any friend, business associate, class mate, e-mail contact, telephone contact, social networking friend or follower, or the like, having personal experience with an appropriate service provider can provide a referral to the inquirer. Referrals can be based on existing information stored in databases or provided by a referrer based on an inquiry. Optionally, the referrer can be incentivized and the system can complete transactions with referred service providers.

### CROSS-REFERENCE TO RELATED APPLICATIONS

This application claims the benefit of priority under 35 U.S.C. 119(e) to U.S. Application No. 62/270,043, filed Dec. 21, 2015, entitled ONLINE FRIEND REFERRAL SYSTEM, by Bojan LIKAR, et al., the contents being hereby incorporated by reference in its entirety.

### FIELD OF THE INVENTION

The invention relates generally to a computerized referral system, and more specifically, to automatically providing referrals of service providers between associates that are seeking referrals.

### BACKGROUND

Consumers can use cold-call resources such as yellow page phone books, newspapers, roaming, or other like for identifying service providers. Many consumers, however, prefer referrals from like-minded friends or associates to prevent the risk of trial and error of choosing service providers without having any direct personal experience with specific service providers.

In the online world, the vast amount of data brought to our fingertips by the Internet as a resource further complicates the process of identifying service providers with even more choices. Conventional web sites such as Angie's List and Yelp! provide ratings submitted by individuals having experience with service providers as a quantitative measure. Also, reviews can be written to tell the story behind an experience with a service provider as a qualitative measure.

Problematically, ratings and reviews are generally open for submission to the public. One issue is that the subjective criteria between random individuals can vary widely, as affected by personal characteristics, geography, industry, and the like. Another issue is that fake reviews are submitted from for both positive and negative reasons.

What is needed is a robust referral-driven online marketplace for automatically connecting service consumers and service providers, based on trusted relationship.

### SUMMARY

The above-mentioned needs are met with methods, computer products, and devices for a computer-implemented referral engine for providing referrals of service providers to associated service consumers utilizing devices over a communication network.

Responsive to detecting a referral event, the referral engine can automatically facilitate referrals for service providers by broadcasting a referral inquiry to associates. Any friend, business associate, class mate, e-mail contact, telephone contact, social networking friend or follower, or the like, having personal experience with an appropriate service provider can provide a referral to the inquirer. Referrals can be based on existing information stored in databases or provided by a referrer based on an inquiry. Optionally, the referrer can be incentivized and the system can complete transactions with referred service providers.

In another embodiment, user activity on a computer device is monitored. Responsive to various types of user activity concerning service providers, a client automatically obtains referrals from a pool of associates and provides results in-line with user activity. For example, users on a service provider web pages are automatically given an ordered list of ratings, social media postings, comments, and the like, of friends for the service provider. In other embodiments, users seek feedback directly from identified associates.

Advantageously, a referral-driven marketplace connects service consumers and service providers to facilitate warm connections.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system for providing referrals of service providers between associates, according to one embodiment.

FIG. 2 is a more detailed block diagram illustrating a referral engine of FIG. 1, according to one embodiment.

FIG. 3 is a schematic diagram illustrating an example user interface on a consumer device of the system in FIG. 1, according to one embodiment.

FIG. 4 is a flow chart illustrating a method for providing referrals of service providers between associates, according to one embodiment.

FIG. 5 is a flow chart illustrating the referral event detection step of the method of FIG. 4, according to some embodiments.

FIG. 6 is a block diagram illustrating an exemplary computing device for implementing the techniques described herein, according to one embodiment.

### DETAILED DESCRIPTION

The present invention provides methods, computer program products, and systems for providing friend referrals of service providers between service consumers and service providers.

Generally, referrals connect a business consumer to a service provider that is known to an associated. Friend status refers to a variety of online relationships. In one instance, friend status is based on social networking (e.g., friends or followers), professional (e.g., e-mail or telephone contacts), or other explicit or implicit associations. A trust relationship (of different levels) for referrals is assumed when two users are connected through certain online or digital formats which the current techniques leverage that identify the need, facilitate the referral, and can complete the transaction for services.

One of ordinary skill in the art will recognize variations to the disclosed embodiments that are contemplated, although no explicitly described.

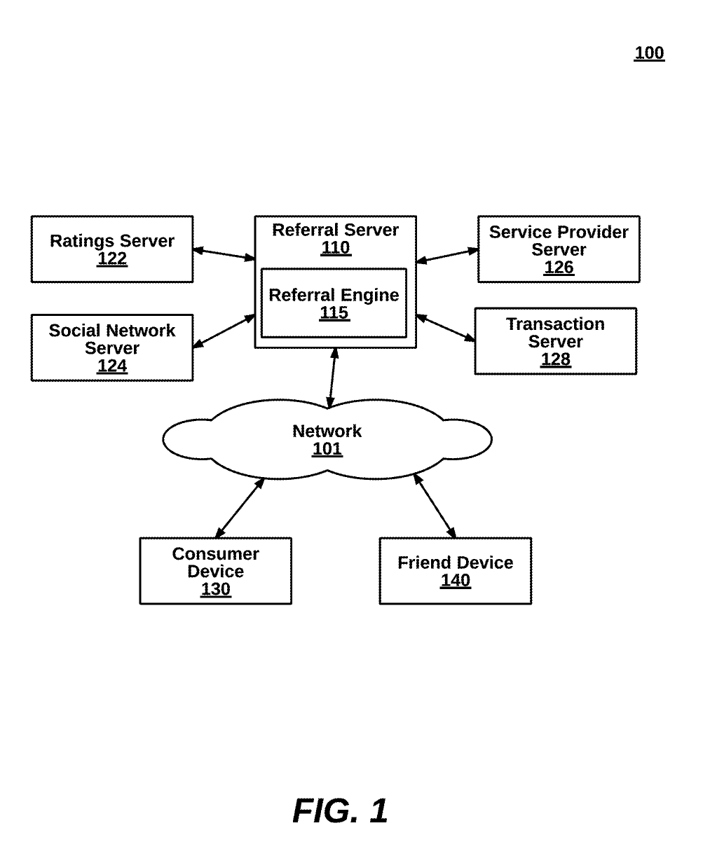

### I. Referral System (FIG. 1)

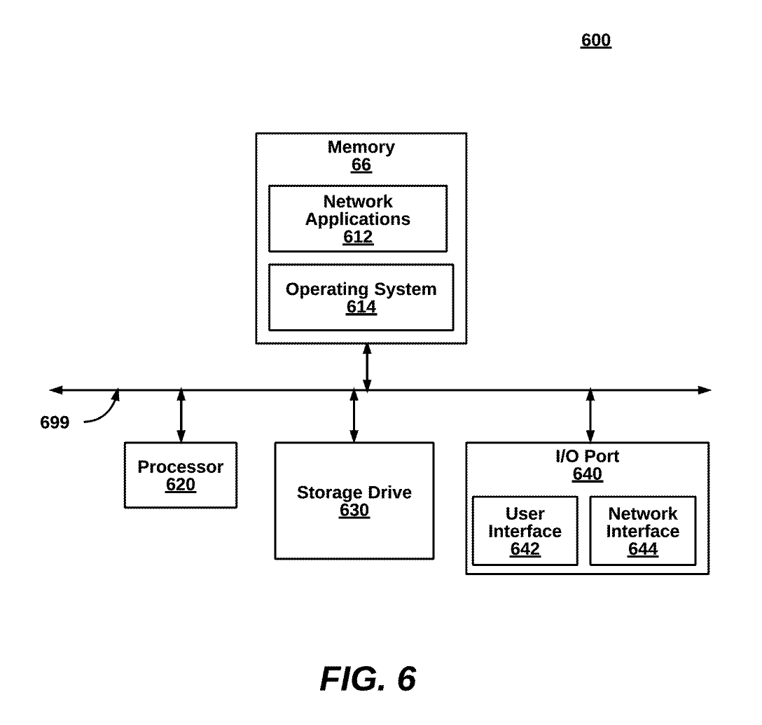

FIG. 1 is a high-level block diagram illustrating a system 100 for providing referrals of service providers between associates, according to one embodiment. The system 100 comprises a referral server 110 and a service provider 126 on the back end, and a consumer device 130 and a friend device 140 to interface with the back end. The components can communicate through a network 101. Additional network components can also be part of the system 100, such as firewalls, virus scanners, routers, switches, application servers, databases, as well as additional controllers, access points, access switches, stations, and the like. The network components can be implemented as hardware, software, or a combination of both (e.g., a shown in FIG. 6). The system 100 can be implemented within an existing online marketplace such as Amazon, within an existing online directory such as Google, or as a separate entity.

The network 101 couples the referral server 110, the consumer device 130 and the friend device 140, as a communication channel. Connections can be wired or wireless. The network 101 can be the Internet, a wide area network, an enterprise network, a local area network, or the like. The network 101 can be a data network, a cellular network, or combination.

The referral server 110 provides an interface for the consumer device 130 for seeking referrals from the friend device 140. On a back end, the referral server 110 further comprises a referral engine 115 in communication with a ratings server 122, a social networking server 124, a service provider 126 and a transaction server 128. In some embodiments, one or more of the back-end components are integrated within the referral server 110. In other embodiments, the back-end components are independent, third party services that are coordinated by the referral server 110 and presented as a unified system to the service consumers.

In operation, the referral engine 115 can create accounts for service consumers, including multiple consumer devices and multiple friend devices. The referral engine 115 as an integration of services uses APIs, plug-ins and other mechanisms to communication through the protocol of external services. There can be one service or many different services hosted by the referral engine 115. In the example of FIG. 1, the referral server 110 interacts with four different third party services. More specifically, the ratings server 122 provides an initial source of information about service providers. For example, service providers can be quantitatively rated with 1 to 5 stars. The social network server 124 provides a source of connections between users. It is these social networking connections, in an embodiment, that defines when a specific set of users can provide referrals (i.e., the consumer device 130 being referred by the friend device 140). The service provider server 126 provides access to a host of service providers to be referred. Finally, the transaction server 128 can close a referral by hosting payment and pay out for purchasing the referred service. Deliverables will be tracked in some cases.

From a more specific level of detail, the consumer device 130 initiates a referral transaction with a referral event. In one example, the referral engine 115 detects a search by the consumer device 130 on the ratings server 122 and, in response, automatically checks with the social network server 124 for connections to a user of the consumer device 130. As a result the referral event, a user of the friend device 140 is identified and a referral inquiry is automatically initiated by the referral engine 115. The friend device 140 in some cases responds with one or more referrals to specific service provider, such as the service provider 126. In some embodiments, the consumer purchases services from the service provider 126 using the transaction server 128 for payment and tracking of deliverables.

The consumer device 130 and the friend device 140 and other components of the system 100 can be any computerized device or processor driven device. Example embodiments include smart telephones, tablets, phablets, laptops, PCs. An example software embodiment includes virtual devices. An example hardware embodiment includes a smart telephone with an app running for communication with the referral engine 115, or a browser pointed to a specific URL associated with a web site of the referral engine 115. More generally, the devices comprise a processor to execute applications and a memory to store application data.

The ratings server 122, in one embodiment can be an external ratings service such as Yelp! or Angie's List or Google and the social network server 124 can be an external platform such as Facebook, Google Circles, Instagram, Snapchat, Google Hangouts, Pinterest, Twitter, and the like. The service provider server 126 can be a directory or business listings, or businesses web sites directly registered with the referral server 110, and the transaction serve 128 can be PayPal, an ACH service, or the like.

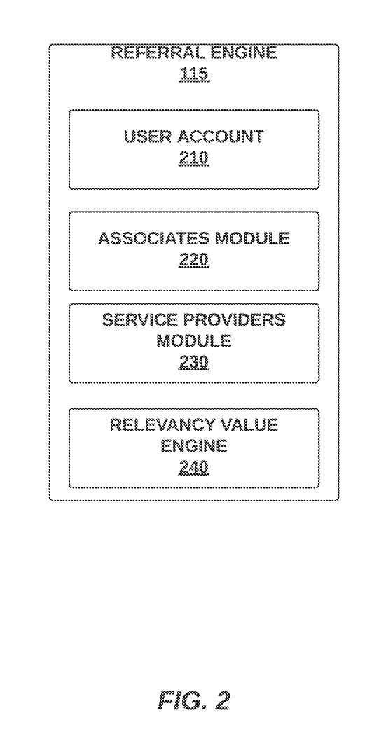

FIG. 2 is a more detailed block diagram illustrating a referral engine 115 of FIG. 1, according to one embodiment. The referral engine 115 comprises a user account 210, an associates module 220, a service providers module 230, and a relevancy value engine 230. Components can be implemented in source code, hardware, or both.

The user account module 210, in an embodiment, collects information about the user to used by the associates module 220 in identifying associates. In one implementation, a list of well-known social networks are presented for users to confirm accounts. Facebook authentication credentials can be collected. Automatically identified accounts can be presented for confirmation. Additionally, custom parameters such as relative weighting and custom rules are configured by users through a user interface.

The associates module 220 can generate a list of associates for each of many users. The associates module 220 can check public records, social networks, e-mail servers, and the like to identify connections between users and others. In some cases, authentication credentials for Facebook are presented by the associates module 220 to access private user account information about connections, known on Facebook as a Friends list. Users provide authentication credentials when setting up a user account. Other social networking platforms examples include Google Circles, Instagram, Snapchat, Google Hangouts, Pinterest, Twitter, and the like. Some embodiments can be extended to friends of friends or other indirect associations. Other systems of trust can include Gmail sender or receiver of email, SMS sender or receiver or text messages, local contacts, phone numbers dialed or received, and the like.

The relevancy value engine 240 implements an algorithm to find referrals responsive to detecting a referral event. The referral events, in one implementation, are sent by a client on a user device that monitors an operating system or an application of the user device. For example, a user browses to a specific service provider web site initiates the algorithm. A relevancy value engine 240 calculates a relevancy value for collected information to enable a ranked list. The relevancy value can be derived from a combination of an associate relationship with user value and the associate relationship with the service provider.

One embodiment of the relevancy value engine 240 calculates a correlation value between the associated and the user, with higher values for closer and more direct connections. For instance, Facebook friends can a higher correlation value than Twitter followers because each of the friends accepts the friendship while followers are unrestricted. Another embodiment of the relevancy value engine 240 calculates a correlation between the associate and the service provider including higher correlation values for closer and more direct experiences. In another instance, a current client of a service provider has a higher correlation value than an associate making random comments or posting an Instagram photo related to the service provider.

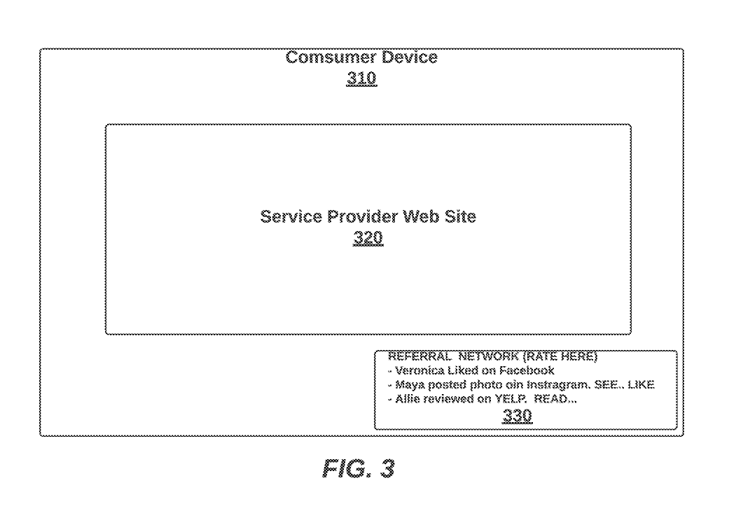

FIG. 3 is a schematic diagram illustrating an example user interface on a consumer device of the system in FIG. 1, according to one embodiment.

When a user lands on the service provider web site 320 a referral network window 330 can pop up within web browser or on an external desktop. The referral network window 330 can display referrers in substantially real-time for quick feedback to the user. Also, the user can initiate the referral process with a request that goes directly to the referrers, or to other associates not shown. For example, Veronica Liked a post, an advertisement, or a company page associated with the service provider on Facebook. A related hyperlink can be included. A button on the user interface can allow the user to initiate a referral requests and the results, such as 4 out of 5 stars or a thumbs up or thumbs down can be displayed as soon as received from the referrer. Other referrer feedback shows that Maya posted a photo related to the service provider on Instagram, and that Allie reviewed the service provider on Yelp.

In another embodiment, feedback to the system by a user as a referrer can be solicited with a Rate Here button, for example. This feedback is stored and connected with others system users. Pop-up windows for real-time feedback requests can also be used to collect feedback form the user.

Many other embodiments are possible. One implementation enhances Yelp reviews when an associate has feedback about a specific service provider review. Another implementation sends a head up message through an augmented reality viewer when looking at a service provider website or store front, for example.

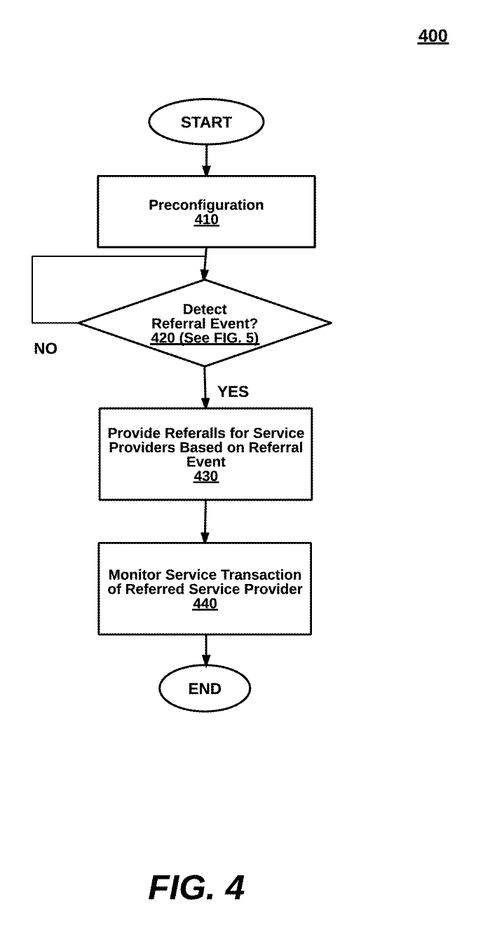

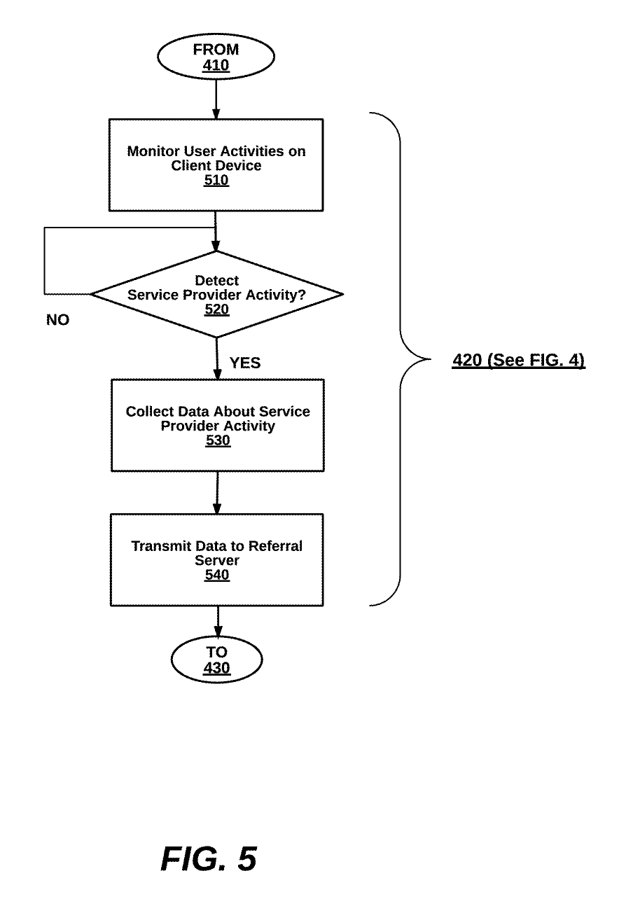

### II. Methods for Friend Referrals (FIGS. 4 and 5)

FIG. 4 is a flow chart illustrating a method 400 for providing referrals of service providers between associates, according to one embodiment. The method 400 is one example of the operation for the system 100 or other referral systems, without limitation.

At step 410, various levels of pre-configuration for referrals are made prior to the real-time steps. In one aspect of pre-configuration, service consumers, service providers, referrers, and others can establish accounts with the referral engine 115. Preferences, login credentials (e.g., to the social network server 124 or the transaction server 128), and other customizations are entered. In another aspect of pre-configuration, users can populate a database (e.g., yelp.com) with ratings and comments about experiences with various service providers.

At step 420, a referral event is detected. As discussed, a referral event can comprise a search on the rating server 122 or the referral server 120, which in turn notifies the referral engine 115. Other referral events can include clicking on an advertisement, a search engine search, or a direct request to the referral engine 115. Detections can occur from various sources including a mobile app, an operating system, the referral server 120, an SDN (software-defined networking) controller, and the like.

At step 430, referrals for service providers are provided responsive to detecting the referral event. In one instance, potential referrers (e.g., using the social network server 124) are provided. In other instances, a contact list or e-mail recipients can be also be potential referrers. In yet other instances, connections to unassociated potential referrers are generated by the referral engine 115 by matching user profiles. The referral transaction continues with specific recommendations from a user that is trusted by the service consumer because of similar experience, taste, locale, or other criteria.

At step 440, a service transaction is monitored. For example, services can be scheduled and paid for through the referral engine 115. Furthermore, deliverables can be tracked through the same platform that generated referrals to complete the transaction.

FIG. 5 is a flow chart illustrating the referral event detection step 420 of the method of FIG. 4, according to some embodiments.

At step 510, user activities are monitored on devices. A software daemon executes in the background and checks operating system messages to keep up with applications in user. A specific user of the user device is determined in some embodiments. An application can be configured with integrated monitoring with a software patch.

At step 520, responsive to user activity detected, at step 530, data is collected about service provider activity. Returning to the example of visiting a web site of a specific service provider, a service provider name, an indication of web browsing activity, a specific user, a date and time, a duration of visit, a history of visits, and other types of information can be collected.

At step 540 collected data is transmitted to a referral server. The user device can include a Wi-Fi radio, a 3G/4G radio, a Bluetooth radio, or a wired connection to the referral server. The specific mode of transport can be transparent to a referral engine operating higher up in a software stack.

### III. Generic Computing Device (FIG. 6)

FIG. 6 is a block diagram illustrating an exemplary computing device 600 for use in the system 100 of FIG. 1, according to one embodiment. The computing device 600 is an exemplary device that is implementable for each of the components of the system 100, including the referral server 110, the ratings server 122, the social network server 124, the service provider server 126, the transaction server 128, the consumer device 130, and the friend device 140. The computing device 600 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 600, of the present embodiment, includes a memory 610, a processor 620, a storage drive 630, and an I/O port 640. Each of the components is coupled for electronic communication via a bus 699. Communication can be digital and/or analog, and use any suitable protocol.

The memory 610 further comprises network applications 612 and an operating system 614. The network applications 612 can include the referral engine 115 or other the components illustrated in FIG. 1. Other network applications 612 can include a web browser, a mobile application, an application that uses networking, a remote application executing locally, a network protocol application, a network management application, a network routing application, or the like.

The operating system 614 can be one of the Microsoft Windows® family of operating systems (e.g., Windows 95, 98, Me, Windows NT, Windows 2000, Windows XP, Windows XP x64 Edition, Windows Vista, Windows CE, Windows Mobile, Windows 8 or Windows 10), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

The processor 620 can be a network processor (e.g., optimized for IEEE 802.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the storage drive 630

The storage drive 630 can be any non-volatile type of storage such as a magnetic disc, EEPROM, Flash, or the like. The storage drive 630 stores code and data for applications.

The I/O port 640 further comprises a user interface 642 and a network interface 644. The user interface 642 can output to a display device and receive input from, for example, a keyboard. The network interface 644 (e.g. RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

### IV. Additional Embodiments

Generally, one of ordinary skill in the art will recognize that the examples set forth herein are non-limiting and only illustrative of widely-applicable principles. Accordingly, this description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A computer-implemented method in a referral server for service provider referrals, implemented at least partially in hardware, the method comprising the steps of:
generating a plurality of associates for a user, each of the plurality of associates determined to have a social characteristic in common with the user;
detecting a referral event associated with the user in which the user seeks a service provider;
in response to the referral event detection, calculating a relevancy value for each of a plurality of associates with respect to the referral event;
identifying a set of referrers from the plurality of associates for requesting a referral of one more service providers, based on a relevancy value each of the plurality of referrers;
retrieving referral information for the referral event from each of the set of referrers, on behalf of the user; and
providing the referral information to the user in substantially real-time with the detected referral event.

2. The method of claim 1, further comprising:
prior to the referral event detection, receiving authentication information for one or more social networks from the user; and
using the authentication information to generate the plurality of associates from connections to the user on the social networks.

3. The method of claim 1, wherein the referral event detection is responsive to receiving a notification from a client that monitors activity of the user on a user device.

4. The method of claim 3, wherein the user activity comprises at least one of: a search query, browsing to a specific web site; a history of web browsing; and interactions with a software application.

5. The method of claim 3, wherein the referral information is displayed at the user device in line with a context of the user activity.

6. The method of claim 1, further comprising:
retrieving information from a ratings database which includes a rating of a specific service provider by a specific associate from the plurality of associates.

7. The method of claim 1, further comprising:
prior to the set of refers identification, calculating the relevancy value for each of the plurality of referrers based on at least a correlation value between an associate and the user, and a correlation value between as associate and the service provider.

8. The method of claim 7, further comprising:
calculating the correlation value between the associate and the user including higher correlation values for closer and direct connections with the user, and lower correlation values for more distant and indirect connections.

9. The method of claim 7, further comprising:
calculating the correlation value between the associate and the service provider including higher correlation values for closer and direct experiences with the service provider, and lower correlation values for more distant and indirect experiences.

10. The method of claim 1, further comprising:
facilitating a transaction between the user and a service provider for a service or product.

11. A non-transitory computer-readable medium, for storing source code that performs a method for service provider referrals when executed by a processor on the referral server, implemented at least partially in hardware, the method comprising the steps of:
generating a plurality of associates for a user, each of the plurality of associates determined to have a social characteristic in common with the user;
detecting a referral event associated with the user in which the user seeks a service provider;
in response to the referral event detection, calculating a relevancy value for each of a plurality of associates with respect to the referral event;
identifying a set of referrers from the plurality of associates for requesting a referral of one more service providers, based on a relevancy value each of the plurality of referrers;
retrieving referral information for the referral event from each of the set of referrers, on behalf of the user; and
providing the referral information to the user in substantially real-time with the detected referral event.

12. The method of claim 11, further comprising:
prior to the referral event detection, receiving authentication information for one or more social networks from the user; and
using the authentication information to generate the plurality of associates from connections to the user on the social networks.

13. The method of claim 11, wherein the referral event detection is responsive to receiving a notification from a client that monitors activity of the user on a user device.

14. The method of claim 13, wherein the user activity comprises at least one of: a search query, browsing to a specific web site; a history of web browsing; and interactions with a software application.

15. The method of claim 13, wherein the referral information is displayed at the user device in line with a context of the user activity.

16. The method of claim 11, further comprising:
retrieving information from a ratings database which includes a rating of a specific service provider by a specific associate from the plurality of associates.

17. The method of claim 11, further comprising:
prior to the set of refers identification, calculating the relevancy value for each of the plurality of referrers based on at least a correlation value between an associate and the user, and a correlation value between as associate and the service provider.

18. The method of claim 17, further comprising:
calculating the correlation value between the associate and the user including higher correlation values for closer and direct connections with the user, and lower correlation values for more distant and indirect connections.

19. The method of claim 17, further comprising:
calculating the correlation value between the associate and the service provider including higher correlation values for closer and direct experiences with the service provider, and lower correlation values for more distant and indirect experiences.

20. The method of claim 11, further comprising:
facilitating a transaction between the user and a service provider for a service or product
